(19) United States
(12) Patent Application Publication
(10) Pub. No.: US 2007/0167544 A1
(43) Pub. Date: Jul. 19, 2007

(54) Ignition resistant polycarbonate polyester composition

(75) Inventors: Subodh Kumar Pal, Bangalore (IN); Abbas Alli G. Shaikh, Bangalore (IN); Gomatam Raghavan Ravi, Bangalore (IN); Deepak Ramaraju, Bangalore (IN)

Correspondence Address: GEAM - O8CV - CPP;IP LEGAL, ONE PLASTICS AVENUE, PITTSFIELD, MA, 01201-3697, US

(73) Assignee: General Electric Company

(21) Appl. No.: 11/334,268

(22) Filed: Jan. 18, 2006

(51) Int. Cl. C08K 5/49; C08L 67/00

(52) U.S. Cl. 524/115; 524/539; 525/418

(57) ABSTRACT

An ignition resistant thermoplastic composition comprising: (a) structural units derived at least one substituted or unsubstituted polycarbonate; (b) a polyester comprising structural units is derived from xylene glycol; (c) 1 weight percent to about 40 weight percent based on the total weight of the composition of a flame retardant compound is disclosed. Also disclosed is a method of making said thermoplastic compositions and articles derived from said composition.

### BACKGROUND OF THE INVENTION

This invention relates to an ignition resistant miscible thermoplastic resin composition, a method to synthesize the composition, and articles made from the compositions.

Polycarbonate is a useful engineering plastic for parts requiring clarity, high toughness, and, in some cases, good heat resistance. However, polycarbonate also has some important deficiencies, among them poor chemical and stress crack resistance, poor resistance to sterilization by gamma radiation, and poor processability. Blends of polyesters with polycarbonates provide thermoplastic compositions having improved properties over those based upon either of the single resins alone. Moreover, such blends are often more cost effective than polycarbonate alone. Many applications of engineering plastics require that these polymers have ignition resistant properties along with other properties such as tensile strength, long-term thermal stability, high heat deflection temperature and chemical resistance.

Clear, miscible blends of any two polymers are rare. The term “miscible”, as used in the specification, refers to blends that are a mixture on a molecular level wherein intimate polymer-polymer interaction is achieved. Miscible blends are clear (transparent), not opaque. In addition, differential scanning calorimetry testing detects only a single glass transition temperature (Tg) for miscible blends composed of two or more components. Thus miscibility of PC with the polyesters gives the blends the clarity needed. In addition maintaining the transparency with addition of ignition retardant (also know herein as flame retardant) additives is difficult.

There have been very few clear polycarbonate/polyester blends developed. U.S. Pat. Nos. 4,619,976 and 4,645,802 disclose clear blends based on bisphenol A polycarbonate with polyesters of poly(1,4-tetramethylene terephthalate), poly(1,4-cyclohexylenedimethylene terephthalate) and selected copolyesters and copoly(ester-imides) of poly(1,4-cyclohexylenedimethylene terephthalate). U.S. Pat. No. 4,786,692 discloses clear blends of bisphenol A polycarbonate and polyesters of terephthalic acid, isophthalic acid, ethylene glycol, and 1,4-cyclohexanedimethanol. U.S. Pat. Nos. 4,188,314 and 4,391,954 disclose clear blends of bisphenol A polycarbonate with poly(1,4-cyclohexylenedimethylene terephthalate-co-isophthalate). These polyester blends do have improved chemical resistance and melt processability, when compared to unblended bisphenol A polycarbonate. However, the good heat resistance and impact strength of bisphenol A polycarbonate blends based on these compositions is reduced significantly. U.S. Pat. Nos. 4,188,314, 4,125,572; 4,391,954; 4,786,692; 4,897,453, and 5,478,896 relate to blends of an aromatic polycarbonate and poly cyclohexane dimethanol phthalate. U.S. Pat. No. 4,125,572 relates to a blend of polycarbonate, polybutylene terephthalate (PBT) and an aliphatic/cycloaliphatic iso/terephthalate resin. U.S. Pat. No. 6,281,299 discloses a process for manufacturing transparent polyester/polycarbonate compositions, wherein the polyester is fed into the reactor after bisphenol A is polymerized to a polycarbonate.

Clear blends of polycarbonate with polyesters containing less than about 10 mole percent of para-xylene glycol have been disclosed in U.S. Pat. Nos. 5,942,585 and 4,564,541. Polyesters modified with of less than about 40 mole percent of any other diol like para-xylene glycol are blended with polycarbonate to give transparent blends have been taught in US2005019784A1 and EP0183141A2. Japanese patents JP07188523 and JP07188525 disclose polycarbonate polyester blends with para-xylene glycol along with impact modifiers like butyl acrylate-glycidyl methacrylate copolymers.

U.S. Pat. Nos. 4,010,219 and 5,955,565 disclose flame resistant blends with polycarbonate and polyesters comprising about less than 20 mole percent of para-xylene glycol. While the French patent FR2140670 and Japanese Patent JP06271752A discuss a blend of halogenated polycarbonate with polyester containing terephthalic acid and para-xylene glycol as one of the diol components.

There is a continuing need for polycarbonate polyester blends having a good balance of optical property, and solvent resistance while retaining good mechanical properties while not compromising on their ignition resistance.

### BRIEF DESCRIPTION OF THE INVENTION

According to an embodiment of the present invention relates to a transparent ignition resistant thermoplastic composition comprising: (a) structural units derived from at least one substituted or unsubstituted polycarbonate; (b) a polyester comprising structural units is derived from xylene glycol; (c) 1 weight percent to about 40 weight percent based on the total weight of the composition of a flame retardant compound. Also disclosed is a method of making said thermoplastic compositions and articles derived from said composition.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester.

As used herein the term “PCCD” is defined as poly(cyclohexane-1,4-dimethylene cyclohexane-1,4-dicarboxylate).

As used herein the term “BPA” refers to bisphenol A.

“Combination” as used herein includes mixtures, copolymers, reaction products, blends, composites, and the like.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

As used herein the term “Ignition resistant” (or “ignition resistance”), or also known as “flame resistant” refers to a composition which pass the flame rating test in accordance with UL-94 testing method.

As used herein the term “aliphatic radical” refers to a radical having a valence of at least one comprising a linear or branched array of atoms which is not cyclic. The array may include heteroatoms such as nitrogen, sulfur, silicon, selenium and oxygen or may be composed exclusively of carbon and hydrogen. Aliphatic radicals may be “substituted” or “unsubstituted”. A substituted aliphatic radical is defined as an aliphatic radical which comprises at least one substituent. A substituted aliphatic radical may comprise as many substituents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g. —CH₂CHBrCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂), carbonyl, dicyanoisopropylidene (i.e. —CH₂C(CN)₂CH₂—), methyl (i.e. —CH₃), methylene (i.e. —CH₂—), ethyl, ethylene, formyl, hexyl, hexamethylene, hydroxymethyl (i.e. —CH₂OH), mercaptomethyl (i.e. —CH₂SH), methylthio (i.e. —SCH₃), methylthiomethyl (i.e. —CH₂SCH₃), methoxy, methoxycarbonyl, nitromethyl (i.e. —CH₂NO₂), thiocarbonyl, trimethylsilyl, t-butyldimethylsilyl, trimethyoxysilypropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” (refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄⁻. Aromatic radicals may be “substituted” or “unsubstituted”. A substituted aromatic radical is defined as an aromatic radical which comprises at least one substituent. A substituted aromatic radical may comprise as many substituents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph-), bromopropylphenyl (i.e. BrCH₂CH₂CH₂Ph-), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh-), aminocarbonylphenyl (i.e. NH₂COPh-), 4-benzoylphenyl, dicyanoisopropylidenebis(4-phenyloxy) (i.e. —OPhC(CN)₂PhO—), 3-methylphenyl, methylenebis(4-phenyloxy) (i.e. —OPhCH₂PhO—), ethylphenyl, phenylethenyl, 3-formyl-2-thienyl, 2-hexyl-5-furanyl; hexamethylene-1,6-bis(4-phenyloxy) (i.e. —OPh(CH₂)₆PhO—); 4-hydroxymethylphenyl (i.e. 4-HOCH₂Ph-), 4-mercaptomethylphemyl (i.e. 4-HSCH₂Ph-), 4-methylthiophenyl (i.e. 4-CH₃SPh-), methoxyphenyl, methoxycarbonylphenyloxy (e.g. methyl salicyl), nitromethylphenyl (i.e. -PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethy group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical which comprises at least one substituent. A substituted cycloaliphatic radical may comprise as many substituents as there are positions available on the cycloaliphatic radical for substitution. Substituents which may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e. —OC₆H₁₁C(CF₃)₂C₆H₁₁O—), chloromethylcyclohexyl; 3-trifluorovinyl-2-cyclopropyl; 3-trichloromethylcyclohexyl (i.e. 3-CCl₃C₆H₁₁—), bromopropylcyclohexyl (i.e. BrCH₂CH₂CH₂C₆H₁₁—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₁—), aminocarbonylcyclopenyl (i.e. NH₂COC₅H₉—), 4-acetyloxycyclohexyl, dicyanoisopropylidenebis(4-cyclohexyloxy) (i.e. —OC₆H₁₁C(CN)₂C₆H₁₁O—), 3-methylcyclohexyl, methylenebis(4-cyclohexyloxy) (i.e. —OC₆H₁₁CH₂C₆H₁₁O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e. —OC₆H₁₁(CH₂)₆C₆H₁₁O—); 4-hydroxymethylcyclohexyl (i.e. 4-HOCH₂C₆H₁₁—), 4-mercaptomethylcyclohexyl (i.e. 4-HSCH₂C₆H₁₁—), 4-methylthiocyclohexyl (i.e. 4-CH₃SC₆H₁₁—), 4-methoxycyclohexyl, 2-methoxycarbonylcyclohexyloxy (2-CH₃OCOC₆H₁₁O—), nitromethylcyclohexyl (i.e. NO₂CH₂C₆H₁₀—), trimethylsilylcyclohexyl, t-butyldimethylsilylcyclopentyl, 4-trimethoxysilyethylcyclohexyl (e.g. (CH₃O)₃SiCH₂CH₂C₆H₁₀—), vinylcyclohexenyl, vinylidenebis(cyclohexyl), and the like. The term “a C₃-C₁₀ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

According to an embodiment of the present invention, the invention includes a transparent ignition resistant thermoplastic composition comprising: (a) structural units derived at least one substituted or unsubstituted polycarbonate; (b) a polyester comprising structural units is derived from xylene glycol; (c) 1 weight percent to about 40 weight percent based on the total weight of the composition of a flame retardant compound. Also disclosed is a method of making said thermoplastic compositions and articles derived from said composition.

A component of the composition of the invention is an aromatic polycarbonate. The aromatic polycarbonate resins suitable for use in the present invention, methods of making polycarbonate resins and the use of polycarbonate resins in thermoplastic molding compounds are well known in the art, see, generally, U.S Pat. Nos. 3,169,121, 4,487,896 and 5,411,999, the respective disclosures of which are each incorporated herein by reference.

Polycarbonates useful in the invention comprise repeating units of the formula (I) 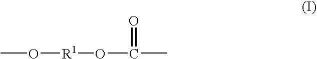
wherein R¹ is a divalent aromatic radical derived from a dihydroxyaromatic compound of the formula HO-D-OH, wherein D has the structure of formula: 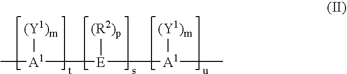
wherein A¹ represents an aromatic group including, but not limited to, phenylene, biphenylene, naphthylene, and the like. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R² independently at each occurrence comprises a monovalent hydrocarbon group including, but not limited to, alkenyl, allyl, alkyl, aryl, aralkyl, alkaryl, or cycloalkyl. In various embodiments a monovalent hydrocarbon group of R² may be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR³ wherein R³ is a monovalent hydrocarbon group including, but not limited to, alkyl, aryl, aralkyl, alkaryl, or cycloalkyl; it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of replaceable hydrogens on A¹ available for substitution; “p” represents an integer from and including zero through the number of replaceable hydrogens on E available for substitution; “t” represents an integer equal to at least one; “s” represents an integer equal to either zero or one; and “u” represents any integer including zero.

In dihydroxy-substituted aromatic hydrocarbons in which D is represented by formula (II) above, when more than one Y¹ substituent is present, they may be the same or different. The same holds true for the R² substituent. Where “s” is zero in formula (II) and “u” is not zero, the aromatic rings are directly joined by a covalent bond with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of dihydroxy-substituted aromatic hydrocarbons E may be an unsaturated alkylidene group. Suitable dihydroxy-substituted aromatic hydrocarbons of this type include those of the formula (III): 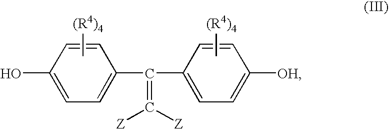
where independently each R⁴ is hydrogen, chlorine, bromine or a C₁₋₃₀ monovalent hydrocarbon or hydrocarbonoxy group, each Z is hydrogen, chlorine or bromine, subject to the provision that at least one Z is chlorine or bromine.

Suitable dihydroxy-substituted aromatic hydrocarbons also include those of the formula (IV): 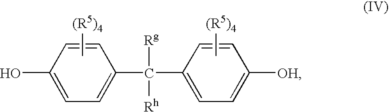
where independently each R⁵ is as defined hereinbefore, and independently R^{g} and R^{h} are hydrogen or a C1-30 hydrocarbon group.

In some embodiments of the present invention, dihydroxy-substituted aromatic hydrocarbons that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, dihydroxy-substituted aromatic hydrocarbons comprise bis(4-hydroxyphenyl)sulfide, bis(4-hydroxyphenyl) ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C1-3alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′-dihydroxydiphenyl; 2-(3-methyl-4-hydroxyphenyl-2-(4-hydroxyphenyl)propane; 2-(3,5-dimethyl4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl) sulfoxide, bis(3,5-dimethyl-4-hydroxyphenyl) sulfone and bis(3,5-dimethylphenyl-4-hydroxyphenyl)sulfide. In a particular embodiment the dihydroxy-substituted aromatic hydrocarbon comprises bisphenol A.

In some embodiments of dihydroxy-substituted aromatic hydrocarbons when E is an alkylene or alkylidene group, said group may be part of one or more fused rings attached to one or more aromatic groups bearing one hydroxy substituent. Suitable dihydroxy-substituted aromatic hydrocarbons of this type include those containing indane structural units such as represented by the formula (V), which compound is 3-(4-hydroxyphenyl)-1,1,3-trimethylindan-5-ol, and by the formula (VI), which compound is 1-(4-hydroxyphenyl)-1,3,3-trimethylindan-5-ol:

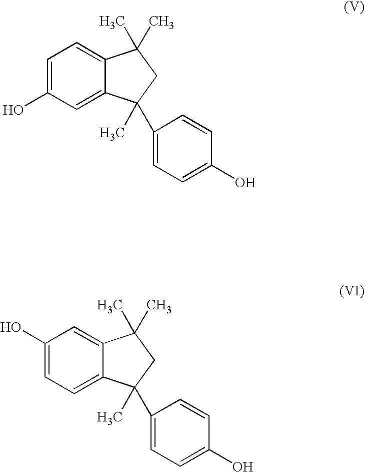

Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols having formula (VII): 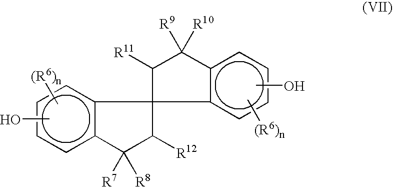
wherein each R⁶ is independently selected from monovalent hydrocarbon radicals and halogen radicals; each R⁷, R⁸, R⁹, and R¹⁰ is independently C1-6 alkyl; each R¹¹ and R¹² is independently H or C1-6 alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′-tetramethyl-1,1′-spirobi[1H-indene]-6,6′-diol (sometimes known as “SBI”). Mixtures of alkali metal salts derived from mixtures of any of the foregoing dihydroxy-substituted aromatic hydrocarbons may also be employed.

The term “alkyl” as used in the various embodiments of the present invention is intended to designate both linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. The term “alkyl” also encompasses that alkyl portion of alkoxide groups. In various embodiments normal and branched alkyl radicals are those containing from 1 to about 32 carbon atoms, and include as illustrative non-limiting examples C1-C32 alkyl optionally substituted with one or more groups selected from C1-C32 alkyl, C3-C15 cycloalkyl or aryl; and C3-C15 cycloalkyl optionally substituted with one or more groups selected from C1-C32 alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those substituted or unsubstituted aryl radicals containing from 6 to 18 ring carbon atoms. Some illustrative non-limiting examples of these aryl radicals include C6-C15 aryl optionally substituted with one or more groups selected from C1-C32 alkyl, C3-C15 cycloalkyl or aryl. Some particular illustrative examples of aryl radicals comprise substituted or unsubstituted phenyl, biphenyl, toluyl and naphthyl.

Mixtures comprising two or more hydroxy-substituted hydrocarbons may also be employed. In some particular embodiments mixtures of at least two monohydroxy-substituted alkyl hydrocarbons, or mixtures of at least one monohydroxy-substituted alkyl hydrocarbon and at least one dihydroxy-substituted alkyl hydrocarbon, or mixtures of at least two dihydroxy-substituted alkyl hydrocarbons, or mixtures of at least two monohydroxy-substituted aromatic hydrocarbons, or mixtures of at least two dihydroxy-substituted aromatic hydrocarbons, or mixtures of at least one monohydroxy-substituted aromatic hydrocarbon and at least one dihydroxy-substituted aromatic hydrocarbon, or mixtures of at least one monohydroxy-substituted alkyl hydrocarbon and at least one dihydroxy-substituted aromatic hydrocarbon may be employed.

In yet another, the polycarbonate resin is a linear polycarbonate resin that is derived from bisphenol A and phosgene. In an alternative embodiment, the polycarbonate resin is a blend of two or more polycarbonate resins.

The aromatic polycarbonate may be prepared in the melt, in solution, or by interfacial polymerization techniques well known in the art. For example, the aromatic polycarbonates can be made by reacting bisphenol-A with phosgene, dibutyl carbonate or diphenyl carbonate. Such aromatic polycarbonates are also commercially available. In one embodiment, the aromatic polycarbonate resins are commercially available from General Electric Company, e.g., LEXAN™ bisphenol A-type polycarbonate resins.

The preferred polycarbonates are preferably high molecular weight aromatic carbonate polymers have an intrinsic viscosity (as measured in methylene chloride at 25° C.) ranging from about 0.30 to about 1.00 deciliters per gram. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

Typically such polyester resins include crystalline or amorphous polyester resins such as polyester resins derived from an aliphatic or cycloaliphatic diol, or mixtures thereof, containing from 2 to about 20 carbon atoms and at least one aromatic dicarboxylic acid. Preferred polyesters are derived from an aliphatic diol and an aromatic dicarboxylic acid and have repeating units according to structural formula (VIII) 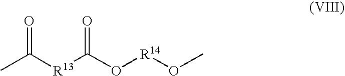
wherein, R¹³ and R¹⁴ are independently at each occurrence a monovalent hydrocarbon group, aliphatic, aromatic and cycloaliphatic radical. In one embodiment R¹⁴ is an alkyl radical compromising a dehydroxylated residue derived from an aliphatic or cycloaliphatic diol, or mixtures thereof, containing from 2 to about 20 carbon atoms and R¹³ is an aromatic radical comprising a decarboxylated residue derived from an aromatic dicarboxylic acid. The polyester is a condensation product where R¹⁴ is the residue of an aromatic, aliphatic or cycloaliphatic radical containing diol having C₁ to C₃₀ carbon atoms or chemical equivalent thereof, and R¹³ is the decarboxylated residue derived from an aromatic, aliphatic or cycloaliphatic radical containing diacid of C₁ to C₃₀ carbon atoms or chemical equivalent thereof. The polyester resins are typically obtained through the condensation or ester interchange polymerization of the diol or diol equivalent component with the diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, stilbene dicarboxylic acid, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, aliphatic esters, e.g., dialiphatic esters, diaromatic esters, anhydrides, salts, acid chlorides, acid bromides, and the like. Examples of aromatic dicarboxylic acids from which the decarboxylated residue R¹ may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g. 1,4-, 1,5-, or 2,6-naphthalene dicarboxylic acids. Preferred dicarboxylic acids include terephthalic acid, isophthalic acid, stilbene dicarboxylic acids, naphthalene dicarboxylic acids, and the like, and mixtures comprising at least one of the foregoing dicarboxylic acids.

Examples of the polyvalent carboxylic acid include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho-phthalic acid, 1,5-naphthalenedicarboxyli acid, 2,6-naphthalenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy]isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

In one embodiment of the present invention the polyester is derived from structural units comprising xylene glycol. In one embodiment of the present invention the polyester is derived from structural units comprising at least one selected from the group consisting of ortho-xylene glycol, meta-xylene glycol, and para-xylene glycol. In one embodiment of the present invention the polyester is derived from structural units comprising para-xylene glycol. In one embodiment the para-xylene glycol is present in an amount at least greater than about 15 mole percent. In another embodiment the para-xylene glycol is present in an amount from about 40 to 100 mole percent. In yet another embodiment the para-xylene glycol is about 100 mole percent.

In one embodiment the polyester may optionally comprise straight chain, branched, or cycloaliphatic diols containing from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. In one embodiment the diol include glycols, such as ethylene glycol, propylene glycol, butanediol, hydroquinone, resorcinol, trimethylene glycol, 2-methyl-1,3-propane glycol, 1,4- butanediol, hexamethylene glycol, decamethylene glycol, 1,4-cyclohexane dimethanol, or neopentylene glycol. Chemical equivalents to the diols include esters, such as dialkylesters, diaryl esters, and the like.

In one embodiment the polyester may optionally comprise polyvalent alcohols which include, but are not limited to, an aliphatic polyvalent alcohol, an alicyclic polyvalent alcohol, and an aromatic polyvalent alcohol, including ethylene glycol, propylene glycol, 1,3-propanediol, 2,3-butanediol, 1,4-butanediol, 1,5- pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerin, pentaerythritol, 1,4-cyclohexanediol, 1,4-cyclohexanedimethanol, spiroglycol, tricyclodecanediol, tricyclodecanedimethanol, m-xylene glycol, o-xylene glycol, 1,4-phenylene glycol, bisphenol A, lactone polyester and polyols. Further, with respect to the polyester resin obtained by polymerizing the polybasic carboxylic acids and the polyhydric alcohols either singly or in combination respectively, a resin obtained by capping the polar group in the end of the polymer chain using an ordinary compound capable of capping an end can also be used.

Preferred polyesters are obtained by copolymerizing para-xylene glycol component and an acid component comprising at least about 0.1 mole %, preferably at least about 95 mole %, of terephthalic acid, or polyester-forming derivatives thereof. In another embodiment, the acid component may comprise at least about 0.1 mole %, preferably at least about 95 mole %, of cyclohexane dicarboxylic acid. The preferred glycol, para-xylene glycol, component can contain up to about 100 mole %, preferably up to about 5 mole % of another glycol, such as ethylene glycol, trimethylene glycol, 2-methyl-1,3-propane glycol, hexamethylene glycol, decamethylene glycol, cyclohexane dimethanol, neopentylene glycol, and the like, and mixtures comprising at least one of the foregoing glycols. The preferred acid component may contain up to about 100 mole %, preferably up to about 50 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethanedicarboxylic acid, sebacic acid, adipic acid, and the like, and polyester-forming derivatives thereof, and mixtures comprising at least one of the foregoing acids or acid derivatives.

Block copolyester resin components are also useful, and can be prepared by the transesterification of (a) straight or branched chain poly(alkylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. Especially useful when high melt strength is important are branched high melt viscosity resins, which include a small amount of, e.g., up to 5 mole percent based on the acid units of a branching component containing at least three ester forming groups. The branching component can be one that provides branching in the acid unit portion of the polyester, in the glycol unit portion, or it can be a hybrid branching agent that includes both acid and alcohol functionality. Illustrative of such branching components are tricarboxylic acids, such as trimesic acid, and lower alkyl esters thereof, and the like; tetracarboxylic acids, such as pyromellitic acid, and lower alkyl esters thereof, and the like; or preferably, polyols, and especially preferably, tetrols, such as pentaerythritol; triols, such as trimethylolpropane; dihydroxy carboxylic acids; and hydroxydicarboxylic acids and derivatives, such as dimethyl hydroxyterephthalate, and the like. Branched poly(alkylene terephthalate) resins and their preparation are described, for example, in U.S. Pat. No. 3,953,404 to Borman. In addition to terephthalic acid units, small amounts, e.g., from 0.5 to 15 mole percent of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like.

The polyesters in one embodiment of the present invention may be a polyether ester block copolymer consisting of a thermoplastic polyester as the hard segment and a polyalkylene glycol as the soft segment. It may also be a three-component copolymer obtained from at least one dicarboxylic acid selected from: aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid or 3-sulfoisophthalic acid, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid or dimeric acid, and ester-forming derivatives thereof; at least one diol selected from: aliphatic diols such as 1,4-butanediol, ethylene glycol, trimethylene glycol, tetramethylene glycol, pentamethylene glycol, hexamethylene glycol, neopentyl glycol or decamethylene glycol, alicyclic diols such as 1,1-cyclohexanedimethanol, 1,4-cyclohexanedimethanol or tricyclodecanedimethanol, and ester-forming derivatives thereof; and at least one poly(alkylene oxide) glycol selected from: polyethylene glycol or poly(1,2- and 1,3-propylene oxide) glycol with an average molecular weight of about 400-5000, ethylene oxide-propylene oxide copolymer, and ethylene oxide-tetrahydrofuran copolymer.

The polyester can be present in the composition at about 1 to about 99 weight percent, based on the total weight of the composition. Within this range, it is preferred to use at least about 25 weight percent, even more preferably at least about 30 weight percent of the polyester. The preferred polyesters are preferably have an intrinsic viscosity (as measured in 60:40 solvent mixture of phenol/tetrachloroethane at 25° C.) ranging from about 0.1 to about 1.5 deciliters per gram. Polyesters branched or unbranched and generally will have a weight average molecular weight of from about 5,000 to about 150,000, preferably from about 8,000 to about 95,000 as measured by gel permeation chromatography using 95:5 weight percent of chloroform to hexafluoroisopropanol mixture.

The polyester component may be prepared by procedures well known to those skilled in this art, such as by condensation reactions. The condensation reaction may be facilitated by the use of a catalyst, with the choice of catalyst being determined by the nature of the reactants. The various catalysts for use herein are very well known in the art and are too numerous to mention individually herein. Generally, however, when an alkyl ester of the dicarboxylic acid compound is employed, an ester interchange type of catalyst is preferred, such as Ti(OC₄H₉)₆ in n-butanol.

In one embodiment the flame retardant compound is at least one selected from the group consisting of phosphorus compounds and halogenated compounds. The flame retardant compound comprises a phosphorus containing compound. Non-limiting examples of phosphorus compounds of the phosphine class are aromatic phosphines, such as triphenylphosphine, tritolylphosphine, trinonylphosphine, trinaphthylphosphine, tetraphenyldiphosphine, tetranaphthyldiphosphine and the like. Suitable phosphine oxides are of the formula (IX) 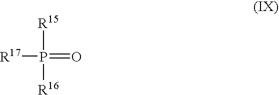
wherein R¹⁵, R¹⁶ and R¹⁷ are independently at each occurrence, selected from the group consisting of a C₁ to C₃₀ aliphatic radical, C₃-C₃₀ cycloaliphatic radical, and C₃-C₃₀ aromatic radical. Examples of phosphine oxides are triphenylphosphine oxide, tritolylphosphine oxide, trisnonylphenylphosphine oxide, tricyclohexylphosphine oxide, tris(n-butyl)phosphine oxide, tris(n-hexyl) phosphine oxide, tris(n-octyl)phosphine oxide, tris(cyanoethyl)phosphine oxide, benzylbis(cyclohexyl)phosphine oxide, benzylbisphenylphosphine oxide and phenylbis(n-hexyl)phosphine oxide. Other suitable compounds are triphenylphosphine sulfide and its derivatives as described above for phosphine oxides and triphenyl phosphate.

Other examples of phosphorus compounds are hypophosphites, e.g. metal hypophosphites where metal is a alkali metal, alkaline earth metal or a transition metal or Al. Ca, Al, Zn, Ti, Mg, Ba and the like and organic hypophosphites, such as cellulose hypophosphite esters, esters of hypophosphorous acids with diols, e.g. that of 1,10-dodecanediol. These compounds may be monomeric or polymeric in structure. Other examples of phosphorus compounds are metal salts of dialkyl or diaryl (also known as “diaromatic”) or arylalkyl phosphinic acid, where metal is a alkali metal, alkalilne earth metal or a transition metal or Al, Ca, Al, Zn, Ti, Mg, Ba and the like. It is also possible to use substituted phosphinic acids and anhydrides of these, e.g. diphenylphosphinic acid. Other possible compounds are di-p-tolylphosphinic acid and dicresylphosphinic anhydride. Compounds such as the bis(diphenylphosphinic)esters of hydroquinone, ethylene glycol and propylene glycol, inter alia, may also be used. Other suitable compounds are aryl(alkyl)phosphinamides, such as the dimethylamide of diphenylphosphinic acid, and sulfonamidoaryl(alkyl)phosphinic acid derivatives, such as p-tolylsulfonamidodiphenylphosphinic acid. In one embodiment the flame retardant compound is bis(diphenylphosphinic)esters of hydroquinone and ethylene glycol and of the bis(diphenylphosphinate) of hydroquinone.

Other suitable examples are derivatives of phosphorous acid. Suitable compounds are cyclic phosphonates which derive from pentaerythritol, from neopentyl glycol or from pyrocatechol. In another embodiment other phosphorus based flame retardants are triaryl(alkyl) phosphites, such as triphenyl phosphite, tris(4-decylphenyl) phosphite, tris(2,4-di-tert-butylphenyl) phosphite and phenyl didecyl phosphite. It is also possible to use diphosphites, such as propylene glycol 1,2-bis(diphosphite) or cyclic phosphites which derive from pentaerythritol, from neopentylglycol or from pyrocatechol.

In one embodiment the flame retardant is at least one selected from the group consisting of neopentyl glycol methylphosphonate and methyl neopentyl glycol phosphite, pentaerythritol dimethyldiphosphonate, dimethyl pentaerythritol diphosphate, tetraphenyl hypodiphosphate and bisneopentyl hypodiphosphate.

Other effective phosphorus based flame retardants are particularly alkyl- and aryl-subsituted phosphates. Examples of these are phenyl bisdodecyl phosphate, phenyl ethyl hydrogen phosphate, phenyl bis(3,5,5-trimethylhexyl) phosphate, ethyl diphenyl phosphate, 2-ethylhexyl ditolyl phosphate, diphenyl hydrogen phosphate, bis(2-ethylhexyl) p-tolyl phosphate, tritolyl phosphate, bis(2-ethylhexyl) phenyl phosphate, di(nonyl) phenyl phosphate, phenyl methyl hydrogenphosphate, di(dodecyl) p-tolyl phosphate, p-tolylbis(2,5,5-trimethylhexyl) phosphate and 2-ethylhexyl diphenyl phosphate. Particularly suitable phosphorus compounds are those in which each radical is aryloxy. Very particularly suitable compounds are triphenyl phosphate, Bisphenol-A bis(diphenyl phosphate) and resorcinol bis(diphenyl phosphate) and its ring-substituted derivatives of formula (X): 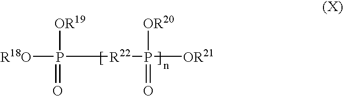
wherein R¹⁸ to R²¹ are each occurrence aromatic radicals having from 6 to 20 carbon atoms, preferably phenyl, which may have substitution by alkyl groups having from 1 to 4 carbon atoms, preferably methyl, R²² is a bivalent phenol radical, preferably and n is an average value of from 0.1 to 100, preferably from 0.5 to 50, in particular from 0.8 to 10 and very particularly from 1 to 5. It is also possible to use cyclic phosphates like for example diphenyl pentaerythritol diphosphate and phenyl neopentyl phosphate are particularly suitable. It is also possible to use inorganic coordination polymers of aryl(alkyl)phosphinic acids, such as poly-β-sodium(I) ethylphenylphosphinate, zinc diethyl phosphinic acid etc.

Other suitable flame retardants are elemental red phosphorous and also compounds that contain phosphorous nitrogen bonds, such as phosphononitrile chloride, phosphoric acid ester amides, phosphoric acid amides, phosphonic acid amides, phosphinic acid amides, tris(aziridinyl)-phosphinic oxide and tetrakis(hydroxymethyl) phosphonium chloride.

In one embodiment the flame retardant may be a halogenated flame retardant. The examples of halogenated flame retardants where brominated flame retardants are preferred are tetrabromobisphenol A derivatives, including bis(2-hydroxyethyl)ether of tetrabromobisphenol A, bis(3-acryloyloxy-2-hydroxypropyl) ether of tetrabromobisphenol A, bis(3-methacryloyloxy-2-hydroxypropyl) ether of tetrabromobisphenol A, bis(3-hydroxypropyl) ether of tetrabromobisphenol A, bis(2,3-dibromopropyl) ether of tetrabromobisphenol A, diallyl ether of tetrabromobisphenol A, and bis(vinylbenzyl) ether of tetrabromobisphenol A; pentabromobenzyl acrylate; dibromostyrenes; tribromostyrenes; tetrabromocyclooctanes; dibromoethyldibromocyclohexanes such as 1,2-dibromo-4-(1,2-dibromoethyl)-cyclohexane; ethylene-bis-tetrabromophthalimide; hexabromocyclododecanes; tetrabromophthalic anhydrides; brominated diphenylethers such as decabromodiphenyl ether; poly(2,6-dibromophenylene ether); and tris(2,4,6-tribromophenoxy-1,3,5-triazine etc.

In one embodiment the halogenated aromatic flame-retardants include but are not limited to tetrabromobisphenol A polycarbonate oligomer, polybromophenyl ether, brominated polystyrene, brominated BPA polyepoxide, brominated imides, brominated polycarbonate, poly (haloaryl acrylate), poly (haloaryl methacrylate), or mixtures thereof. Examples of other suitable flame retardants are brominated polystyrenes such as polydibromostyrene and polytribromostyrene, decabromobiphenyl ethane, tetrabromobiphenyl, brominated alpha, omega-alkylene-bis-phthalimides, e.g. N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins. Flame retardant compounds also include brominated thermosetting resins, for example a brominated poly(epoxide), or a poly(arylene ether) having a phosphorous-containing moiety in its backbone.

The amount of flame retardant will vary with the nature of the resin and with the efficiency of the additive. In one embodiment the amount of flame retardant is present in an amount between about 1 weight percent to about 40 weight percent. In another embodiment the flame retardant is present in an amount between about 5 weight percent to about 30 weight percent.

In one embodiment optionally a synergist may be employed along with the flame retardant compound. The synergist amount is chosen such that desired level of transparency is not affected. The synergist may be an inorganic antimony compound. Such compounds are widely available or can be made in known ways. Typical, inorganic synergist compounds include Sb₂O₅, SbS₃, sodium antimonate and the like. Especially preferred is antimony trioxide (Sb₂O₃). Synergists such as antimony oxides, are typically used at about 0.1 to 10 by weight based on the weight percent of resin in the final composition. Also, the final composition may contain polytetrafluoroethylene (PTFE) type resins or copolymers used to reduce dripping in flame retardant thermoplastics. Also other halogen-free flame retardants than the mentioned P or N containing compounds can be used, non limiting examples being compounds as Zn-borates, hydroxides or carbonates as Mg- and/or Al-hydroxides or carbonates, Si-based compounds like silanes or siloxanes, Sulfur based compounds as aryl sulphonates (including salts of it) or sulphoxides, Sn-compounds as stannates can be used as well often in combination with one or more of the other possible flame retardants.

In one embodiment of the present invention the thermoplastic resin composition may optionally comprise stabilizing additives. In another embodiment the stabilizing additives may be a quenchers are used in the present invention to stop the polymerization reaction. Quenchers are agents inhibit activity of any catalysts that may be present in the resins to prevent an accelerated interpolymerization and degradation of the thermoplastic. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. In one embodiment of the quenchers are for example of phosphorous containing compounds, boric containing acids, aliphatic or aromatic carboxylic acids i.e., organic compounds the molecule of which comprises at least one carboxy group, anhydrides, polyols.

In one embodiment of the present invention a catalyst may be employed. The catalyst can be any of the catalysts commonly used in the prior art such as alkaline earth metal oxides such as magnesium oxides, calcium oxide, barium oxide and zinc oxide; alkali and alkaline earth metal salts; a Lewis catalyst such as tin or tinanium compounds; a nitrogen-containing compound such as tetra-alkyl ammonium hydroxides used like the phosphonium analogues, e.g., tetra-alkyl phosphonium hydroxides or acetates. The Lewis acid catalysts and the catalysts can be used simultaneously.

Inorganic compounds such as the hydroxides, hydrides, amides, carbonates, phosphates, borates, etc., of alkali metals such as sodium, potassium, lithium, cesium, etc., and of alkali earth metals such as calcium, magnesium, barium, etc., can be cited such as examples of alkali or alkaline earth metal compounds. Examples include sodium stearate, sodium carbonate, sodium acetate, sodium bicarbonate, sodium benzoate, sodium caproate, or potassium oleate.

In one embodiment of the invention, the catalyst is selected from one of phosphonium salts or ammonium salts (not being based on any metal ion) for improved hydrolytic stability properties. In another embodiment of the invention, the catalyst is selected from one of: a sodium stearate, a sodium benzoate, a sodium acetate, and a tetrabutyl phosphonium acetate. In yet another embodiment of the present invention the catalysts is selected independently from a group of sodium stearate, zinc stearate, calcium stearate, magnesium stearate, sodium acetate, calcium acetate, zinc acetate, magnesium acetate, manganese acetate, lanthanum acetate, lanthanum acetylacetonate, sodium benzoate, sodium tetraphenyl borate, dibutyl tinoxide, antimony trioxide, sodium polystyrenesulfonate, PBT-ionomer, titanium isoproxide and tetraammoniumhydrogensulfate and mixtures thereof. In an alternative embodiment the here said catalyst may be a compound of the form M(OR¹⁰)_{q} where M is an alkaline earth or akline metal, metal or transitional metals such as sodium, potassium, lithium, cesium, etc., and of alkali earth metals such as calcium, magnesium, barium, etc. metals and transitional metals like aluminium, magnesium, manganese, zinc, titanium, nickel and R¹⁰ can be an aliphatic or aromatic organic compound such as methyl, ethyl, propyl, phenyl etc and q is the valence of the metal corresponding to the compound.

In one embodiment the catalysts include, but are not limited to metal salts and chelates of Ti, Zn, Ge, Ga, Sn, Ca, Li and Sb. Other known catalysts may also be used for this step-growth polymerization. The choice of catalyst being determined by the nature of the reactants. In one embodiment of the present invention the reaction mixture comprises at least two catalysts. The various catalysts for use herein are very well known in the art and are too numerous to mention individually herein. A few examples of the catalysts which may be employed in the above process include but are not limited to titanium alkoxides. such as tetramethyl, tetraethyl, tetra(n-propyl), tetraisopropyl and tetrabutyl titanates; dialkyl tin compounds, such as di-(n-butyl) tin dilaurate di-(n-butyl) tin oxide and di-(n-butyl) tin diacetate; and oxides acetate salts and sulfate salts of metals, such as magnesium, calcium, germanium, zinc, antimony, etc. In one embodiment the catalyst is titanium alkoxides. The catalyst level is employed in an effective amount to enable the copolymer formation and is not critical and is dependent on the catalyst that is used. Generally the catalyst is used in concentration ranges of about 10 to about 500 ppm, preferably about is less than about 300 ppm and most preferably about 20 to about 300 ppm.

In another embodiment a catalyst quencher may optionally be added to the reaction mixture. The choice of the quencher is essential to avoid color formation and loss of clarity of the thermoplastic composition. In one embodiment of the invention, the catalyst quenchers are phosphorus containing derivatives, examples include but are not limited to diphosphites, phosphonates, metaphosphoric acid; arylphosphinic and arylphosphonic acids; polyols; carboxylic acid derivatives and combinations thereof. The amount of the quencher added to the thermoplastic composition is an amount that is effective to stabilize the thermoplastic composition. In one embodiment the amount is at least about 0.001 weight percent, preferably at least about 0.01 weight percent based on the total amounts of said thermoplastic resin compositions. The amount of quencher used is thus an amount which is effective to stabilize the composition therein but insufficient to substantially deleteriously affect substantially most of the advantageous properties of said composition.

In one embodiment, a composition of the invention may contain an impact modifier in an amount that is sufficient to enable a composition to retain a transparency such that the composition has a value of transmission greater than about 60% in the region of about 400 nm to about 800 nm. The composition of the invention generally does not contain an appreciable amount of impact modifiers, such as polyethylene, polypropylene, MBS, ABS, acrylic rubbers, ethylene-glycidyl methacrylate copolymers, ethylene-acrylic acid ionomers, polyisoprene, polybutadiene or polyalkylene ether glycols or core-shell impact modifiers. In one embodiment, the amount of the impact modifiers is less than about 5%. In one embodiment, the amount of the impact modifiers is less than about 2%. In one embodiment, there is no impact modifier in the composition of the invention.

The composition of the present invention may further include additives which do not interfere with the previously mentioned desirable properties but enhance other favorable properties such as anti-oxidants, reinforcing materials, colorants, mold release agents, fillers, nucleating agents, UV light and heat stabilizers, lubricants, and the like. Additionally, additives such as antioxidants, minerals such as talc, clay, mica, and other stabilizers including but not limited to UV stabilizers, such as benzotriazole, supplemental reinforcing fillers such as flaked or milled glass, and the like, flame retardants, pigments or combinations thereof may be added to the compositions of the present invention.

The compositions may, optionally, further comprise a reinforcing filler. The amount of filler is adjusted to retain the level of transparency desired for the part molded of final composition. The fillers may be of natural or synthetic, mineral or non-mineral origin, provided that the fillers have sufficient thermal resistance to maintain their solid physical structure at least at the processing temperature of the composition with which it is combined. Suitable fillers include clays, nanoclays, carbon black, wood flour either with or without oil, various forms of silica (precipitated or hydrated, fumed or pyrogenic, vitreous, fused or colloidal, including common sand), glass, metals, inorganic oxides (such as oxides of the metals in Periods 2, 3, 4, 5 and 6 of Groups Ib, IIb, IIIa, IIIb, IVa, IVb (except carbon), Va, VIa, VIIa and VIII of the Periodic Table), oxides of metals (such as aluminum oxide, titanium oxide, zirconium oxide, titanium dioxide, nanoscale titanium oxide, aluminum trihydrate, vanadium oxide, and magnesium oxide), hydroxides of aluminum or ammonium or magnesium, carbonates of alkali and alkaline earth metals (such as calcium carbonate, barium carbonate, and magnesium carbonate), antimony trioxide, calcium silicate, diatomaceous earth, fuller earth, kieselguhr, mica, talc, slate flour, volcanic ash, cotton flock, asbestos, kaolin, alkali and alkaline earth metal sulfates (such as sulfates of barium and calcium sulfate), titanium, zeolites, wollastonite, titanium boride, zinc borate, tungsten carbide, ferrites, molybdenum disulfide, asbestos, cristobalite, aluminosilicates including Vermiculite, Bentonite, montmorillonite, Na-montmorillonite, Ca-montmorillonite, hydrated sodium calcium aluminum magnesium silicate hydroxide, pyrophyllite, magnesium aluminum silicates, lithium aluminum silicates, zirconium silicates, and combinations comprising at least one of the foregoing fillers. Suitable fibrous fillers include glass fibers, basalt fibers, aramid fibers, carbon fibers, carbon nanofibers, carbon nanotubes, carbon buckyballs, ultra high molecular weight polyethylene fibers, melamine fibers, polyamide fibers, cellulose fiber, metal fibers, potassium titanate whiskers, and aluminum borate whiskers.

Alternatively, or in addition to a particulate filler, the filler may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

Optionally, the fillers may be surface modified, for example treated so as to improve the compatibility of the filler and the polymeric portions of the compositions, which facilitates deagglomeration and the uniform distribution of fillers into the polymers. One suitable surface modification is the durable attachment of a coupling agent that subsequently bonds to the polymers. Use of suitable coupling agents may also improve impact, tensile, flexural, and/or dielectric properties in plastics and elastomers; film integrity, substrate adhesion, weathering and service life in coatings; and application and tooling properties, substrate adhesion, cohesive strength, and service life in adhesives and sealants. Suitable coupling agents include silanes, titanates, zirconates, zircoaluminates, carboxylated polyolefins, chromates, chlorinated paraffins, organosilicon compounds, and reactive cellulosics. The fillers may also be partially or entirely coated with a layer of metallic material to facilitate conductivity, e.g., gold, copper, silver, and the like.

In a preferred embodiment, the reinforcing filler comprises glass fibers. For compositions ultimately employed for electrical uses, it is preferred to use fibrous glass fibers comprising lime-aluminum borosilicate glass that is relatively soda free, commonly known as “E” glass. However, other glasses are useful where electrical properties are not so important, e.g., the low soda glass commonly known as “C” glass. The glass fibers may be made by standard processes, such as by steam or air blowing, flame blowing and mechanical pulling. Preferred glass fibers for plastic reinforcement may be made by mechanical pulling. The diameter of the glass fibers is generally about 1 to about 50 micrometers, preferably about 1 to about 20 micrometers. Smaller diameter fibers are generally more expensive, and glass fibers having diameters of about 10 to about 20 micrometers presently offer a desirable balance of cost and performance. The glass fibers may be bundled into fibers and the fibers bundled in turn to yarns, ropes or rovings, or woven into mats, and the like, as is required by the particular end use of the composition. In preparing the molding compositions, it is convenient to use the filamentous glass in the form of chopped strands of about one-eighth to about 2 inches long, which usually results in filament lengths between about 0.0005 to about 0.25 inch in the molded compounds. Such glass fibers are normally supplied by the manufacturers with a surface treatment compatible with the polymer component of the composition, such as a siloxane, titanate, or polyurethane sizing, or the like.

When present in the composition, the filler may be used at about 0 to about 10 weight percent, based on the total weight of the composition.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl) propionic acid with mono- or polyhydric alcohols, e.g., with methanol, diethylene glycol, octadecanol, triethylene glycol, 1,6-hexanediol, pentaerythritol, neopentyl glycol, tris(hydroxyethyl) isocyanurate, thiodiethylene glycol, N,N-bis(hydroxyethyl) oxalic acid diamide. Typical, UV absorbers and light stabilizers include i) 2-(2′-hydroxyphenyl)-benzotriazoles, for example, the 5′methyl-3′5′-di-tert-butyl-5′-tert-butyl-5′(1,1,3,3-tetramethylbutyl)-5-chloro-3′,5′-di-tert-butyl-5-chloro-3′tert-butyl-5′methyl-3′sec-butyl-5′tert-butyl-4′-octoxy,3′,5′-ditert-amyl-3′,5′-bis-(alpha,alpha-dimethylbenzyl)-derivatives; ii) 2.2 2-Hydroxy-benzophenones, for example, the 4-hydroxy-4-methoxy-4-octoxy4-decloxy-4-dodecyloxy-4-benzyloxy,4,2′,4′-trihydroxy- and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate.

The composition can further comprise one or more anti-dripping agents, which prevent or retard the resin from dripping while the resin is subjected to burning conditions. Specific examples of such agents include silicone oils, silica (which also serves as a reinforcing filler), asbestos, and fibrillating-type fluorine-containing polymers. Examples of fluorine-containing polymers include fluorinated polyolefins such as, for example, poly(tetrafluoroethylene), tetrafluoroethylene/hexafluoropropylene copolymers, tetrafluoroethylene/ethylene copolymers, polyvinylidene fluoride, poly(chlorotrifluoroethylene), and the like, and mixtures comprising at least one of the foregoing anti-dripping agents. A preferred anti-dripping agent is poly(tetrafluroethylene). When used, an anti-dripping agent is present in an amount of about 0.02 to about 2 weight percent, and more preferably from about 0.05 to about 1 weight percent, based on the total weight of the composition.

Dyes or pigments may be used to give background coloration. Dyes are typically organic materials that are soluble in the resin matrix while pigments may be organic complexes or even inorganic compounds or complexes, which are typically insoluble in the resin matrix. These organic dyes and pigments include the following classes and examples: furnace carbon black, titanium oxide, zinc sulfide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

Typically the additive is generally present in amount corresponding to about 0 to about 1.5 weight percent based on the amount of resin. In another embodiment the additive is generally present in amount corresponding to about 0.01 to about 0.5 weight percent based on the amount of resin.

The range of composition of the thermoplastic resin of the present invention is from about 90 to 10 weight percent of the polycarbonate component, 10 to about 90 percent by weight of the polyester component. In yet another embodiment the polycarbonate is present in an amount that is at least about 35 weight percent. In one embodiment the polycarbonate is present in an amount ranging from about 40 to about 90 weight percent, based on the total weight of the composition. In yet another embodiment the polycarbonate is present in an amount ranging from about 45 to about 85 weight percent, based on the total weight of the composition. In one embodiment, the composition comprises about 75-25 weight percent polycarbonate and 25-75 weight percent of the polyester component.

A molding composition of the invention has a novel combination of components that impart useful properties to the composition and articles molded from the composition, e.g., transparency and char yield. In one embodiment of the present invention the composition transmits greater than about 60 percent light in the region ranging from about 400 nm to about 800 nm. In another embodiment, the composition transmits in the range of between about 65 and about 99 percent light in the region of about 400 nm to about 800 nm.

In one embodiment of the present invention the composition has a char yield of at least 4%. In another embodiment the char yield is ranging from about 4% to about 30%.

In one embodiment of the present invention the composition are prepared by melt processes. The process may be a continuous polymerization process where in the said reaction is conducted in a continuous mode in a train of reactor of a at least 2 reactors in series or in parallel and the here said reactants and additives inclusive of catalysts are all added in the first reactor or either in any of the reactor in the train. In an alternate embodiment the process may be a batch polymerization process where in the reaction is conducted in a batch mode either in a single vessel or in multiple vessels and the reaction can be conducted in two or more stages depending on the number of reactor and the process conditions. In an alternate embodiment, the process can be carried out in a semi continuous polymerization process where the reaction is carried out in a batch mode. In one embodiment the additives are added continuously. In another embodiment the reaction is conducted in a continuous mode where the polymer is removed continuously and the reactants or additives are added in a batch process.

In one embodiment of the present invention the process may be in one embodiment be carried out in an inert atmosphere. In another embodiment the process may be carried out in nitrogen, argon or carbon dioxide atmosphere. The inert atmosphere may be either nitrogen or argon or carbon dioxide. The heating of the various ingredients may be carried out in a temperature between about 90° C. and about 230° C. In one embodiment the blend of the present invention, polycarbonates, polyester, is polymerized by extrusion at a temperature ranging from about 225 to 350° C. for a sufficient amount of time to produce a composition characterized by a single Tg. In one embodiment the process may optionally be carried out at a pressure of about 0.01 kPa to atmospheric pressure. In yet another embodiment the vacuum is between 0.01 kPa to 80 kPa.

The reaction may be conducted optionally in presence of a solvent or in neat conditions without the solvent. The organic solvent used in the above process according to the invention should be capable of dissolving the polyester and polycarbonate to an extent of at least 0.01 g/per ml at 25° C. and should have a boiling point in the range of 140-290° C. at atmospheric pressure. Preferred examples of the solvent include but are not limited to amide solvents, in particular, N-methyl-2-pyrrolidone; N-acetyl-2-pyrrolidone; N,N′-dimethyl formamide; N,N′-dimethyl acetamide; N,N′-diethyl acetamide; N,N′-dimethyl propionic acid amide; N,N′-diethyl propionic acid amide; tetramethyl urea; tetraethyl urea; hexamethylphosphor triamide; N-methyl caprolactam and the like. Other solvents may also be employed, for example, methylene chloride, chloroform, 1,2-dichloroethane, tetrahydrofuran, diethyl ether, dioxane, benzene, toluene, chlorobenzene, o-dichlorobenzene and the like.

In one embodiment the composition may be made by conventional blending techniques. The production of the compositions may utilize any of the blending operations known for the blending of thermoplastics, for example blending in a kneading machine such as a Banbury mixer or an extruder. To prepare the composition, the components may be mixed by any known methods. Typically, there are two distinct mixing steps: a premixing step and a melt mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device.

In one embodiment of the present invention the composition could be prepared by solution method. The solution method involves dissolving all the ingredients in a common solvent (or) a mixture of solvents and either precipitation in a non-solvent or evaporating the solvent either at room temperature or a higher temperature of at least about 50° C. to about 80° C. In one embodiment, the reactants can be mixed with a relatively volatile solvent, preferably an organic solvent, which is substantially inert towards the polymer, and will not attack and adversely affect the polymer. Some suitable organic solvents include ethylene glycol diacetate, butoxyethanol, methoxypropanol, the lower alkanols, chloroform, acetone, methylene chloride, carbon tetrachloride, tetrahydrofuran, and the like. In one embodiment of the present invention the non solvent is at least one selected from the group consisting of mono alcohols such as ethanol, methanol, isopropanol, butanols and lower alcohols with C1 to about C12 carbon atoms. In one embodiment the solvent is chloroform.

In one embodiment, the ingredients are pre-compounded, pelletized, and then molded. Pre-compounding can be carried out in conventional equipment. For example, after pre-drying the polyester composition (e.g., for about four hours at about 120° C.), a single screw extruder may be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) may be fed downstream. The pre-compounded composition can be extruded and cut up into molding compounds such as conventional granules, pellets, and the like by standard techniques. The composition can then be molded in any equipment conventionally used for thermoplastic compositions, such as a Newbury type injection molding machine with conventional cylinder temperatures, at about 230° C. to about 280° C., and conventional mold temperatures at about 55° C. to about 95° C.

The molten mixture of the polyester may be obtained in particulate form, example by pelletizing or grinding the composition. The composition of the present invention can be molded into useful articles by a variety of means by many different processes to provide useful molded products such as injection, extrusion, rotation, foam molding calender molding and blow molding and thermoforming, compaction, melt spinning form articles. Non limiting examples of the various articles that could be made from the thermoplastic composition of the present invention include electrical connectors, electrical devices, computers, building and construction, outdoor equipment. The articles made from the composition of the present invention may be used widely in house ware objects such as food containers and bowls, home appliances, as well as films, electrical connectors, electrical devices, computers, building and construction, outdoor equipment, trucks and automobiles. In one embodiment the polyester may be blended with other conventional polymers.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

TABLE 1
Abbreviation

| | |
|---|---|
| DMCD | 1,4-cyclohexane dimethyl dicarboxylate |
| CHDM | 1,4-cyclohexane dimethanol |
| PXG | Para-xylene glycol |
| BDO | 1,4-Butanediol |
| DMT | Dimethyl terephthalate |
| PCT | Poly(1,4-cyclohexyl dimethylene terephthalate) |
| DMI | Dimethyl isophthalate |
| PBT | Poly(butylene terephthalate) |
| PXD | Poly(p-xylene 1,4-cyclohexane dicarboxylate) |
| PXI | Poly(p-xylene Dimethyl isophthalate) |
| FR | Flame Retardant |
| DEDA-TPA | Bis(4-carboethoxy)1,4-diphenyl terephthalamide |
| DEDA-CHDA | Bis(4-carboethoxy)1,4-diphenyl cyclohexylamide |
| T_{g} | Glass Transition Temperature |
| Tₘ | Melting Temperature |
| T_{Cr} | Crystallization Temperature |
| I.V | Intrinsic Viscosity |
| BPADP | Bisphenol-A diphosphate |
| PCCD | poly(1,4-cyclohexyl dimethylene-1,4-cyclohexane |
| | dicarboxylate) |
| PET | Poly(ethylene terephthalate) |
| WEEE | Waste Electrical and Electronic Equipment |
| TCE | Tetrachloroethane |
| GPC | Gel Permeation Chromatography |
| DSC | Differential Scanning Calorimetry |
| YI | Yellowness Index |
| RDP | Resorcinol Diphosphate |
| BPA-Et | 2,2-Bis[4-3,4-dicarboxyphenoxy)phenyl]propane- |
| | bis(p-carboxyethylphenyl)imide |
| BPA-EA | 2,2-Bis[4-3,4-dicarboxyphenoxy)phenyl]propane |
| | bis(2-hydroxyethyl)imide |
| KSS | Potassium diphenyl sulfone sulfonate |

### Preparation of Flame Retardant Blends: General Method

Examples 1 to 7 and comparative examples 1-7 Blends were made with polycarbonate obtained from General Electric Company as Lexan® polycarbonate resin blended with the corresponding polyesters. The blends were obtained by mixing known amounts of polycarbonate, polyesters and different FR additives by weights as given in Table 2. The blending was carried out on a 25 mm Werner & Pfleiderer ZSK co-rotating Twin Screw Extruder with a screw speed of about 300 rotation per minute. The compounding was carried out at a temperature of about 100° C. which was gradually increased to 200-240-255-265-265-265-270-270-270° C. to form a melt. The melt was then extruded in the form of strand that was cooled through a water bath prior to pelletization. The pellets were dried for about 4 hours at about 100° C. in a forced air-circulating oven prior to molding. The samples were injection molded in 85 Ton Injection Molding machine as per ISO test protocol requirements. The temperature profile used for injection molding was 100-240-250-260-265° C.

Tensile properties of the injection molded specimens were evaluated as per ISO 527. Flame performance evaluation was done with different thickness flame bars in accordance with UL-94 testing method. Flame retardancy tests were performed following the procedure of Underwriter's Laboratory Bulletin 94 entitled “Tests for Flammability of Plastic Materials, UL94.” According to this procedure, materials may be classified as HB, V0, V1, V2, VA and/or VB on the basis of the test results obtained for five samples. In a V-series test, to achieve a rating of V0, in a sample placed so that its long axis is 180 degrees to the flame, the individual period of flaming or smoldering after removing the igniting flame does not exceed ten seconds and none of the vertically placed samples produces drips of burning particles that ignite absorbent cotton. Five bar flame out time (FOT) is the sum of the flame out time for five bars, each lit twice for a maximum flame out time of 50 seconds. To achieve a rating of V1, in a sample placed so that its long axis is 180 degrees to the flame, the individual period of flaming or smoldering after removing the igniting flame does not exceed thirty seconds and none of the vertically placed samples produces drips of burning particles that ignite absorbent cotton. Five bar flame out time is the sum of the flame out time for five bars, each lit twice for a maximum flame out time of 250 seconds. Compositions of this invention are expected to achieve a UL94 rating of V1 and/or V0at a thickness of preferably 1.5 mm or lower. Chemical resistance test was evaluated as per ISO 4599. The molded, standard ISO/ASTM Tensile bars are conditioned at 23+\−2 deg C. and (50+/−5)% relative humidity for at least 48 hrs prior to the test. After conditioning, the bars are fixed on to the specified strain fixtures that provided the required strain level. The intimate contact of the bar and fixtures is maintained along the entire length of the gage area to be tested One set (five bars) of the strained bar is exposed to the specified temperature and the chemical reagent. One set of bar is strained identically to the bar being exposed but with no chemical reagent. This acts as reference or control. After the specified exposure period, Visual examination is carried out to note for any appearance changes, crazes, cracks, discoloration etc. The mechanical properties, like the Tensile properties, Yield Stress and Nominal Strain at Break of the unexposed control and exposed bar were determined within about 24 hrs after removal from chemical reagent and from strain fixtures.

TABLE 2

| Sr No. | Polymer | Char % by TGA in N2 at 800 C. |
|---|---|---|
| 1 | PCCD | 0.9 |
| 2 | PCTG | 2 |
| 3 | PETG | 2 |
| 4 | PCT | 2 |
| 5 | PXD | 8 |
| 6 | PXI | 21 |
| 7 | BPA-Et-PCCD | 13 |
| 8 | BPA-Et-PXD | 18 |

TABLE 3

| | C. Ex. 1 | C. Ex. 2 | C. Ex. 3 | Ex. 1 | Ex. 2 | CEx. 4 | CEx. 5 | Ex. 3 | Ex. 4 |
|---|---|---|---|---|---|---|---|---|---|
| PC | 75.0 | 75.0 | 58.4 | 58.4 | 58.7 | 53.4 | 58.4 | 58.7 | 58.4 |
| PCCD | 25.0 | — | 26.3 | — | — | 26.3 | 26.3 | — | — |
| PCTG | — | 25.0 | — | — | — | — | — | — | — |
| PXD | — | — | — | 26.3 | 26.3 | — | — | 26.3 | 26.3 |
| KSS salt | — | — | 0.3 | 0.3 | | 0.3 | 0.3 | — | 0.3 |
| Brominated PC | — | — | 15.0 | 15.0 | 15.0 | 20.0 | — | — | — |
| RDP | — | — | — | — | — | — | 15.0 | 15.0 | — |
| Pentaerythritol | — | — | — | — | — | — | — | — | 15.0 |
| Diphosphonate | | | | | | | | | |
| Properties | | | | | | | | | |
| UL-94 Flame @ 3.0 mm | V2 | V2 | V2 | V0 | V0 | V2 | V2 | V0 | V0 |
| UL-94 Flame @ 2.3 mm | V2 | V2 | V2 | V0 | V0 | V2 | V2 | V0 | V2 |
| Tensile Strength (MPa) | 54 | 60 | — | — | — | — | 2400 | 2600 | — |
| Tensile Modulus (MPa) | 1980 | 2300 | — | — | — | — | 63 | 66 | — |
| Elongation @ Break (%) | 100 | 65 | — | — | — | — | 80 | 45 | — |
| Chemical Res @ Ethanol | Fail | Pass | — | — | — | — | Fail | Pass | — |
| Chemical Res @Isopropanol | Fail | Pass | — | — | — | — | Fail | Pass | — |
| Optical Properties | | | | | | | | | |
| % Transmission | 89.3 | 90 | 89 | 86 | 83.4 | 86 | 86.2 | 83 | |

The char content of different polyesters are shown in Table-2 and the flame retardant blend compositions along with the properties are shown in Table 3 and 4. All the blends obtained showed transparency, which is an indicative of the miscibility of these polyesters with PC and the flame retardant compound used in the formulation. From the table 3, it is evident that all the formulations with PCCD as a polyester are giving only V2 flammability rating whereas the use of PXD as a polyester in the same composition improves the flammability rating to V0 @ 3.0 mm as well as @ 2.3 mm thickness from V2 rating @ both the thickness. Both organic phosphates and brominated flame-retardants show better flame resistance. Also mechanical and chemical resistance properties are maintained.

TABLE 4

| | C. Ex. 6 | C. Ex. 7 | Ex. 5 | Ex. 6 | Ex. 7 |
|---|---|---|---|---|---|
| PC | 58.7 | 58.7 | 58.7 | 58.7 | 58.7 |
| PXD-BPAEt (15%) | — | — | 26.3 | 26.3 | 26.3 |
| PCCD-BPAEt (15%) | 26.3 | 26.3 | — | — | — |
| Brominated PC | 15.0 | — | — | 10.0 | — |
| RDP | — | 15.0 | 15.0 | — | 10.0 |
| Properties | | | | | |
| UL-94 Flame @ 3.0 mm | V2 | V2 | V0 | V0 | V0 |
| UL-94 Flame @ 2.3 mm | V2 | V2 | V0 | V0 | V0 |
| UL-94 Flame @ 1.5 mm | V2 | V2 | V0 | V2 | V2 |
| UL-94 Flame @ 0.8 mm | V2 | V2 | V0 | V2 | V2 |
| Tensile Strength (MPa) | — | — | 67 | 65 | 62 |
| Tensile Modulus (MPa) | — | — | 2700 | 2800 | 2600 |
| Elongation @ Break (%) | — | — | 42 | 4 | 5 |
| Chemical Res @ Ethanol | — | — | Pass | — | — |
| Chemical Res @Isopro- | — | — | Pass | — | — |
| panol % Transmission | | | | | |
| Haze | 86.3 | | 80.1 | 84 | 78.3 |

To increase the char content further, we incorporated BPA-Et moiety in the PCCD and PXD backbone and it gives the char content of 10-15% based on the % of BPA-Et used in the polymerization. Here in spite of high char content in BPA-Et PCCD, it gives only V2 rating while BPA-Et PXD gives us V0 at the thickness up to 0.8 mm thickness which is given in Table-4. The role of PXG in PXD is very critical to give good quality char and to improve the flame resistance of the composition. So by this invention we can achieve V0 up to 0.8 mm thickness with good clarity and mechanical properties.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and published articles cited herein are incorporated herein by reference.

1. A thermoplastic composition comprising:
(a) structural units derived from at least one substituted or unsubstituted polycarbonate;
(b) a polyester comprising structural units is derived from xylene glycol;
(c) from 1 weight percent to about 40 weight percent based on the total weight of the composition of a flame retardant compound,
wherein the composition is transparent, and
wherein the components (a), (b) and (c) are in sufficient amounts to make the composition ignition resistant.

2. The composition of claim 1, wherein the polycarbonate comprises repeating units of the formula: 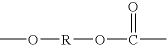
wherein R is a divalent aromatic radical derived from a dihydroxyaromatic compound of the formula HO-D-OH, wherein D has the structure of formula: 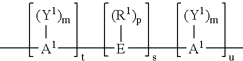
wherein A¹ represents an aromatic group; E comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl;
R¹ independently at each occurrence comprises a mono-valent hydrocarbon group, aliphatic, aromatic, or a cycloaliphatic radical;
Y¹ independently at each occurrence is selected from the group consisting of an inorganic atom, a halogen; an inorganic group, a nitro group; an organic group, a monovalent hydrocarbon group, alkenyl, allyl, alkyl, aryl, aralkyl, alkaryl, cycloalkyl, and an alkoxy group;
the letter “m” represents any integer from and including zero through the number of replaceable hydrogens on A¹ available for substitution;
the letter “p” represents an integer from and including zero through the number of replaceable hydrogens on E available for substitution;
the letter “t” represents an integer equal to at least one;
the letter “s” represents an integer equal to either zero or one; and
“u” represents any integer including zero.

3. The composition of claim 2, wherein the dihydroxyaromatic compound from which D is derived is bisphenol A.

4. The composition of claim 1, wherein the polyester is derived from structural units comprising at least one substituted or unsubstituted diacid and xylene glycol.

5. The composition of claim 4, wherein the diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

6. The composition of claim 1, wherein the xylene glycol is selected from the group consisting of para-xylene glycol, ortho-xylene glycol, meta-xylene glycol and mixtures thereof.

7. The composition of claim 1, wherein the xylene glycol is in an amount ranging from about 15 mole percent to about 100 mole percent.

8. The composition of claim 6, wherein the xylene glycol is para-xylene glycol.

9. The composition of claim 1, wherein the polyester further comprises structural units derived from a diol selected from the group consisting of ethylene glycol;
propylene glycol, butanediol, pentane diol; dipropylene glycol; 2-methyl-1,5-pentane diol; 1,6-hexane diol; decalin dimethanol, bicyclo octane dimethanol; 1,4-cyclohexane dimethanol; triethylene glycol; 1,10-decane diol; tricyclodecane dimethanol; hydrogenated bisphenol-A, tetramethyl cyclobutane diol, chemical equivalents of the foregoing, and combinations thereof.

10. The composition of claim 1, wherein the polyester is present in an amount ranging from about 10 to about 90 weight percent, based on the total weight of the composition.

11. The composition of claim 1, wherein the polyester is present in an amount ranging from about 25 to about 75 weight percent, based on the total weight of the composition.

12. The composition of claim 1, wherein the polycarbonate is present ranging about 90 to about 10 weight percent, based on the total weight of the composition.

13. The composition of claim 1, wherein the polycarbonate is present ranging from about 75 to about 25 weight percent, based on the total weight of the composition.

14. The composition of claim 1, wherein the flame retardant compound is selected from the group consisting of brominated flame-retardants, phosphorus containing compounds and combinations thereof.

15. The composition of claim 1, wherein the flame retardant is present ranging from about 5 weight percent to about 30 weight percent, based on the amount of the total composition.

16. The composition of claim 1, wherein the composition further comprises an additive.

17. The composition of claim 16, wherein the additive is selected from the group consisting of anti-oxidants, flow modifiers, impact modifiers, colorants, mold release agents, UV light stabilizers, heat stabilizers, lubricants, anti-drip agents and combinations thereof.

18. The composition of claim 16, wherein the additive is present ranging from about 0 to 1.5 weight percent, based on the total weight of the thermoplastic resin.

19. The composition of claim 1, wherein the composition has an intrinsic viscosity of at least greater than about 0.55 dL/g.

20. The composition of claim 1, wherein the composition has a glass transition temperature in the range between about 40° C. and about 130° C.

21. The composition of claim 1, wherein the composition has a char yield of at least greater than about 4%.

22. The composition of claim 1, wherein the composition transmits about greater than 60 percent light in the region of about 400 nm to about 800 nm.

23. The composition of claim 1, wherein the composition is resistant to deterioration from contact with organic alcohols.

24. An article molded from the composition of claim 1.

25. A process to prepare an ignition resistant thermoplastic composition comprising:
(a) structural units derived from at least one substituted or unsubstituted polycarbonate;
(b) a polyester comprising structural units is derived from xylene glycol;
(c) from 1 weight percent to about 40 weight percent based on the total weight of the composition of a flame retardant compound;
wherein the composition is transparent and wherein the process comprises the steps of:
i. mixing the polycarbonate and polyester to form a first mixture; and
ii. heating the first mixture to form the transparent composition.

26. The process of claim 25, wherein the process is carried out in presence of a catalyst.

27. The process of claim 26, wherein the catalyst is selected from the group consisting of alkali metal and alkaline earth metal salts of aromatic dicarboxylic acids, alkali metal and alkaline earth metal salts of aliphatic dicarboxylic acids, Lewis acids, metal oxides, coordination complexes of the foregoing and combinations thereof.

28. The process of claim 25, wherein the process is carried out in presence of a solvent.

29. A thermoplastic composition comprising:
(a) structural units derived from at least one substituted or unsubstituted polycarbonate;
(b) a polyester comprising structural units is derived from xylene glycol;
(c) from 1 weight percent to about 40 weight percent based on the total weight of the composition of a flame retardant compound; wherein the flame retardant compound is at least one selected from the group consisting of brominated flame retardants and phosphorus containing compounds;
wherein the composition is transparent and wherein the components (a), (b) and (c) are in sufficient amounts to make the composition ignition resistant.
